(19) United States
(12) Patent Application Publication
(10) Pub. No.: US 2018/0315359 A1
(43) Pub. Date: Nov. 1, 2018

(54) ADVERTISING DEVICE USING BUS

(71) Applicant: JG INDUSTRY CO., LTD., Seoul (KR)

(72) Inventor: Jae Man JO, Seoul (KR)

(73) Assignee: JG INDUSTRY CO., LTD., Seoul (KR)

(21) Appl. No.: 15/983,012

(22) Filed: May 17, 2018

Related U.S. Application Data
(63) Continuation of application No. PCT/KR2016/013308, filed on Nov. 18, 2016.

(30) Foreign Application Priority Data
Nov. 20, 2015 (KR) 10-2015-0163132

(51) Int. Cl. G09F 21/04; G01C 21/36; G06Q 30/02; G01C 21/34

(52) U.S. Cl. CPC G09F 21/04; G01C 21/3697; H04W 4/029; G06Q 30/0266; G01C 21/3476; G06Q 30/0259

(57) ABSTRACT

Disclosed is an advertising device which is installed at the top of a bus running a route. The disclosed advertising device displays an optimized advertisement according to a position of the bus in which the same is installed. In addition, the advertising device displays an advertisement in association with another advertising device installed at the top of another bus and thereby can maximize the advertising effectiveness.

### CROSS-REFERENCE TO RELATED APPLICATIONS

The present application is a continuation of International Patent Application No. PCT/KR2016/013308, filed Nov. 18, 2016, which is based upon and claims the benefit of priority to Korean Patent Application No. 10-2015-0163132, filed on Nov. 20, 2015. The disclosures of the above-listed applications are hereby incorporated by reference herein in their entirety.

### BACKGROUND

Embodiments of the inventive concept described herein relate to an advertising device, and more particularly, relate to an advertising device using a bus.

Buses are public transportation which travels per set time along a predetermined route on the ground. Buses are exposed to many persons due to their characteristics and obtain the attention of peoples' eyes whenever moved.

Thus, a variety of methods of providing an advertisement using buses have been proposed, for example, a method of installing a billboard on a bus has been proposed. However, since most advertising methods are to simply attach a billboard on which advertisement contents are shown to a side of a bus, they do not optimize advertising effects.

### SUMMARY

Embodiments of the inventive concept provide an advertising device for displaying an optimized advertisement video or an optimized advertisement image depending on a position of a bus.

Embodiments of the inventive concept provide an advertising device for optimizing an advertising effect by grouping advertising devices respectively installed on buses.

According to an aspect of an embodiment, an advertising device installed in a bus which travels along a route may include a storage unit configured to store a video or image, a display unit, and a playback unit configured to load the video or image to display the video or image on the display unit.

The advertising device may further include a power supply unit configured to receive power from a battery of the bus and supply the received power to the display unit.

The advertising device may further include a fixing unit configured to fix the advertising device to an upper end of the bus using a screw, a rivet, a frame, or adhesive.

The playback unit may be configured to, when a position set for the video or image is located within a predetermined distance from a position of the bus, display the video or image on the display unit.

The playback unit may be configured to, when the bus is in a first position on the route, load and display a video or image corresponding to a second position on the route in the video or image.

The video or image may include at least one of broadcast information, an advertisement, and traffic information associated with the route.

According to another aspect of an embodiment, an advertising device installed in an upper end of a bus which travels along a route may include a position estimation unit configured to estimate a current position of the bus, a display unit, and a controller configured to control the display unit to display a video or image selected based on the estimated position.

The advertising device may further include a transmitter configured to transmit information about the estimated position to a server and a receiver configured to receive a video or image selected according to the estimated position from the server. The controller may be configured to control the display unit to display the received video or image on the outside of the bus.

The advertising device may further include a storage unit configured to store a plurality of videos or images and an advertisement selecting unit configured to compare a position set for each of the plurality of stored videos or images with the estimated position and select a video or image to be displayed among the plurality of stored videos or images. The controller may be configured to control the display unit to display the selected video or image on the outside of the bus.

The video or image may be selected when a position set for the video or image is located within a predetermined distance from the estimated position.

The position estimation unit may be configured to estimate a first position on the route as a current position of the bus. The video or image may be selected when a position set for the video or image is located within a predetermined distance from a second position on the route.

The selected video or image may be a portion of the entire video or image. The other of the entire video or image may be displayed on a display device installed on another bus.

The controller may be configured to, when a position of the bus is located within a predetermined range from a position of the other bus, the controller is configured to control the display unit to display the selected video or image.

The advertising device may further include a transmitter configured to transmit information about the estimated current position of the bus to a server and a receiver. The current position of the bus may be compared with a position of the other bus. The receiver may be configured to receive the selected video or image as a result of the comparison. The controller may be configured to control the display unit to display the received video or image.

The advertising device may further include a beacon transmitting unit configured to transmit a beacon signal, a response signal receiving unit configured to, when the other bus receives the beacon signal, receive a response signal including an identifier of the other bus from the other bus, and a determination unit configured to, when the response signal is received, determine that the bus is close to the other bus.

The advertising device may further include a message transmitting unit configured to transmit a connection advertisement request message including an identifier of the bus and an identifier of the other bus to a server and a receiver configured to receive the selected video or image from the server. The controller may be configured to control the display unit to display the received video or image. The other of the entire video or image may be transmitted to the other bus with reference to the identifier of the other bus, the identifier being included in the connection advertisement request message.

According to another aspect of an embodiment, an advertising device installed in an upper end of a bus which travels along a route may include a grouping unit configured to recognize another bus adjacent to the bus or another advertising device installed on the other bus and form a group with the other advertising device, a receiver configured to receive a control signal from a master advertising device selected between the advertising device and the other advertising device, and a display unit configured to display a video or image based on the control signal.

The advertising device installed on a bus which first stops between the bus and the other bus may be selected as the master advertising device.

The receiver may be configured to receive the video or image from the master advertising device. The display unit may be configured to display the received video or image.

The receiver may be configured to receive the video or image from a server with reference to the control signal. The display unit may be configured to display the received video or image.

The grouping unit may be configured to form the group in consideration of at least one of a traveling direction of each of the bus and the other bus, a speed of each of the bus and the other bus, whether each of the bus and the other bus stops, or a time when each of the bus and the other bus stops.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a drawing illustrating the concept of an advertising device installed on an upper end of a bus which travels along a predetermined route according to an exemplary embodiment;

FIG. 2 is a block diagram illustrating a structure of an advertising device installed on an upper end of a bus;

FIG. 3 is a drawing illustrating the concept of an advertising device which displays an optimized advertisement depending on a position of a bus;

FIG. 4 is a block diagram illustrating a structure of an advertising device which receives an advertisement from a server and displays the advertisement according to an exemplary embodiment;

FIG. 5 is a block diagram illustrating a structure of an advertising device which selects and displays an advertisement depending on a position of a bus;

FIG. 6 is a drawing illustrating the concept of an advertising device which interacts with an advertising device installed on another bus and displays an advertisement;

FIG. 7 is a block diagram illustrating a structure of an advertising device which interacts with an advertising device installed on another bus;

FIG. 8 is a drawing illustrating the concept of controlling another advertising device installed on another bus;

FIG. 9 is a block diagram illustrating a structure of an advertising device which controls another advertising device installed on another bus;

FIG. 10 is a drawing illustrating the concept of grouping advertising devices respectively installed on buses which stop at a bus stop and displaying an advertisement;

FIG. 11 is a drawing illustrating the concept of grouping advertising devices respectively installed on buses which stop at an intersection and displaying an advertisement; and

FIG. 12 is a drawing illustrating the concept of grouping advertising devices respectively installed on buses which stop around a crosswalk and displaying an advertisement.

### DETAILED DESCRIPTION

Hereinafter, a description will be given in detail of embodiments with reference to the accompanying drawings.

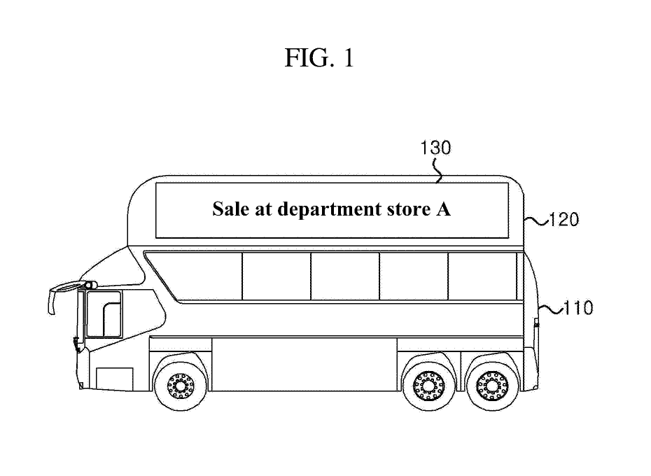

FIG. 1 is a drawing illustrating the concept of an advertising device installed on an upper end of a bus which travels along a predetermined route according to an exemplary embodiment.

According to an aspect, an advertising device 120 may have a display device 130 and may display at least one of broadcast information, an advertisement, and traffic information associated with a route of a bus 110 on the display device 130.

According to an aspect, the advertising device 120 may be installed on the outside of the bus 110, for example, a front surface, a rear surface, a side surface, or an upper end of the bus 110, to transmit information to a pedestrian on a road or a passenger which rides in another bus. Alternatively, the advertising device 120 may be installed on the inside of the bus 110 to transmit information a passenger in the bus 110. Hereinafter, an embodiment is exemplified as the advertising device 120 is installed on the upper end of the bus 110. However, the advertising device 120 according to embodiments of the inventive concept may be installed on a front surface, a rear surface, a side surface, an upper end, or the inside of the bus 110. The inventive concept should not be construed in a limiting sense as the advertising device 120 is installed on the upper end of the bus 110.

When the advertising device 120 is installed on the upper end of the bus 110, people may view an advertisement displayed on the display device 130 in an area far away from the bus 110. Further, when the advertising device 120 is installed on the upper end of the bus 110, it does not obstruct the view of most vehicles, such as taxies or cars, heights of drivers of which are lower than that of the advertising device 120, and may expose its advertisement to a pedestrian around a road or a passenger who rides in another bus.

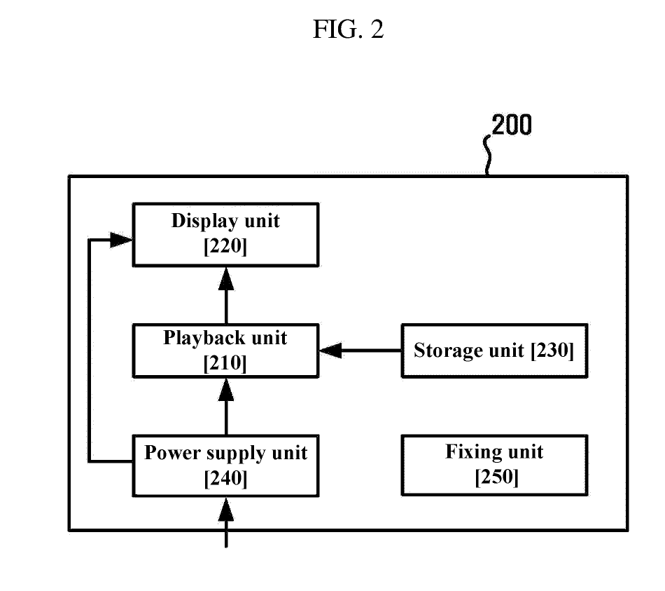

FIG. 2 is a block diagram illustrating a structure of an advertising device installed on an upper end of a bus.

An advertising device 200 according to an exemplary embodiment may include a playback unit 210, a display unit 220, a storage unit 230, a power supply unit 240, and a fixing unit 250.

The storage unit 230 may store a video or an image. According to an aspect, a flash memory, a hard disc, or the like may be used as the storage unit 230.

The display unit 220 may be a display device which plays back a video or an image. Herein, a video or an image played back on the display unit 220 may include at least one of broadcast information, an advertisement, and traffic information associated with a route of a bus.

The playback unit 210 may load a video or image stored in the storage unit 230 to display the video or image on the display 220.

The power supply unit 240 may receive power from a battery of the bus. Herein, the battery of the bus may be a battery included in a power system of the bus, which receives power from a generator directly connected to an engine of the bus or may be a battery additionally installed to supply power to the advertising device 120. According to an aspect, to supply power to the advertising device 120, a separate power supply device may be added to the bus. For example, a solar power generator may be added to the bus to supply power generated by the solar power generator to the power supply unit 240.

The power supply unit 240 may supply the received power to the display unit 220, the playback unit 210, or the like. According to an aspect, the power supply unit 240 may change a voltage of the received power and may supply the changed power to the display unit 220, the playback unit 210, or the like.

The fixing unit 250 may fix the advertising device 200 to the bus. According to an aspect, the fixing unit 250 may fix the advertising device 200 to an upper end of the bus using a screw, a rivet, adhesive, or the like. According to an aspect, a frame may be mounted on an upper end of the bus to bind a main body of the bus to the advertising device 200, and the advertising device 200 may be installed on the frame.

According to an aspect, the storage unit 230 may store a plurality of videos or images. In this case, the playback unit 210 may select any one of the plurality of videos or any one of the plurality of images and may display the selected video or image on the display unit 220.

In this case, the playback unit 210 may select a video or image to be displayed on the display unit 220, based on a position set for each video or image. For example, when a position set for a video or image stored in the storage unit 230 is included within a predetermined distance from a position of the bus, the playback unit 210 may display the video or image on the display unit 220.

According to another embodiment, the playback unit 210 may select a video or image to be displayed, in consideration of a route of the bus. For example, when the bus equipped with the advertising device 200 is in a first position on a route, the playback unit 210 may select a video or image corresponding to a second position on the route among videos or images stored in the storage unit 230 as a video or image to be displayed.

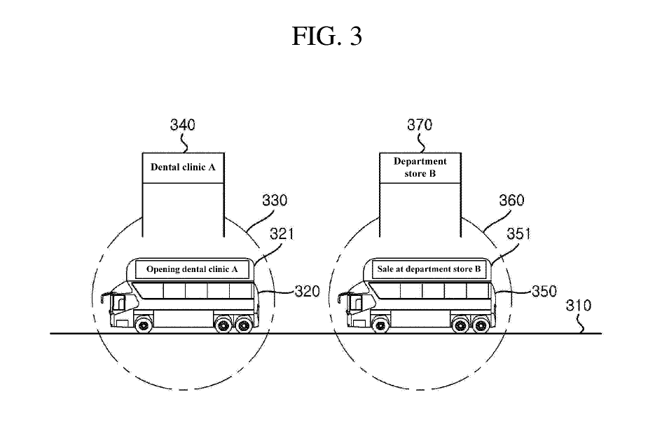

FIG. 3 is a drawing illustrating the concept of an advertising device which displays an optimized advertisement depending on a position of a bus.

A bus may travel along a predetermined route on the ground 310. The route along which the bus travels may very long. A pedestrian in a first position on the route may not interest in a second position on the route at all. In this case, it is inefficient to display an advertisement corresponding to the second location on the bus located in the first position.

Advertising devices 321 and 351 according to an exemplary embodiment may estimate current locations of buses 320 and 350 respectively equipped with the advertising devices 321 and 351, respectively, and may display optimized advertisements on their display units 450 depending on the estimated positions, respectively.

To this end, respective advertisements may be stored in connection with a specific location. For example, the advertisement “opening dental clinic A” may be stored in connection with a position of “dental clinic A 340”, and the advertisement “sale at department store B” may be stored in connection with a position of “department store B 370”.

Each of the advertising devices 321 and 351 respectively installed on the buses 320 and 350 may select an optimized video or image using a position stored in connection with a stored video or image. For example, when a position of the first bus 320 is close to a position of “dental clinic A 340”, the advertising device 321 installed on the first bus 320 may display the advertisement “opening dental clinic A”, stored in connection with the position of “dental clinic 340” which is close to the position of the first bus 320, as an advertisement optimized for the first bus 320. Likewise, the advertising device 351 installed on the second bus 350 may display the advertisement “sale at department store B”, stored in connection with the position of “department store B 370” which is close to the position of the second bus 350, as an advertisement optimized for the second bus 350.

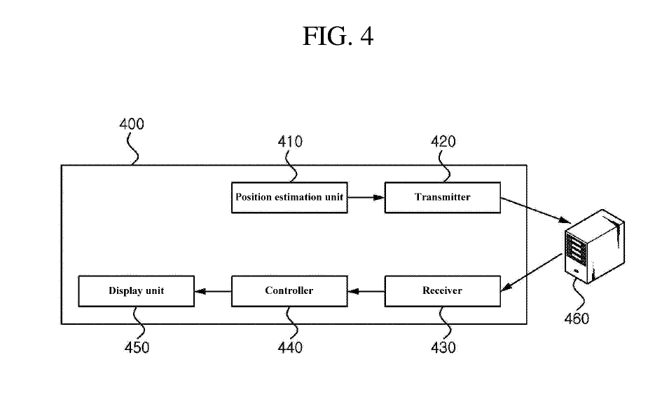

FIG. 4 is a block diagram illustrating a structure of an advertising device which receives an advertisement from a server and displays the advertisement according to an exemplary embodiment.

An advertising device 400 according to an exemplary embodiment may include a position estimation unit 410, a transmitter 420, a receiver 430, a controller 440, and a display unit 450.

The position estimation unit 410 may estimate a current position of a bus equipped with the advertising device 400. According to an aspect, the position estimation unit 410 may estimate the current position of the bus using a global positioning system (GPS) or the like.

The transmitter 420 may transmit the estimated position of the bus to a server 460. The server 460 may store a plurality of videos or a plurality of images. The estimated position of the bus may be used to select a video or image optimized for the bus.

The receiver 430 may receive a video or image selected according to the estimated position of the bus from the server 460.

The controller 440 may control the display unit 450 installed on the outside of the bus or the outside or the advertising device 400 to display the received video or image.

According to an embodiment shown in FIG. 4, the advertising device 400 may transmit information about the estimated current position of the bus to the server 460. The server 460 may select an optimized video or image depending on a position of the bus.

According to an aspect, a specific geographical position may be set for each of videos or images stored in the server 460. For example, a geographical position of “dental clinic A” may be set for the advertisement “opening dental clinic A”. A geographical position of “department store B” may be set for the advertisement “sale at department store B”.

In this case, when a position set for each of videos or images is included within a predetermined distance from the estimated position of the bus, the server 460 may select a corresponding advertisement and may transmit the selected advertisement to the receiver 430. For example, when the position set for “dental clinic A” is included within a predetermined distance (e.g., 100 m) from the estimated position of the bus, the server 460 may select the advertisement image “opening dental clinic A” as an advertisement optimized for the advertising device 400 and may transmit the selected advertisement.

Further, the server 460 may select an advertisement optimized for the advertising device 400 installed on the bus in consideration of a route along which the bus travels. According to an aspect, when the bus is in a first position on the route, the position estimation unit 410 may estimate a current position of the bus as the first position. In this case, the server 460 may receive information about the first position on the route and may select advertisements associated with a second position on the route as an optimal advertisement, an optimal image, or an optimal video. When a position set for a video or image is included within a predetermined distance from the second position on the route, the server 460 may select a corresponding advertisement as an optimal video, an optimal image, or an optimal advertisement. The selected video or image may be located in a place far away from a current position of the bus, but may be located in a place where a pedestrian is able to easily arrive when he or she rides in the bus. Thus, an advertising effect may be optimized.

According to another embodiment, the advertising device 400 may display an advertisement according to an administrative district, a country, or the like where the bus is positioned.

The transmitter 420 may transmit information about an estimated position of the bus to the server 460. The server 460 may receive the information about the estimated position of the bus and may determine the administrative district or the country where the bus is positioned, using the estimated position of the bus.

The server 460 may select a video or image, a set position of which corresponds to the administrative district or the country where the bus is positioned, among a plurality of videos or images and may transmit the selected video or image to the advertising device 400.

The receiver 430 may receive the selected image or video from the server 460. The controller 440 may control the display unit 450 installed on the outside of the bus or the outside of the advertising device 400 to display the received video or image.

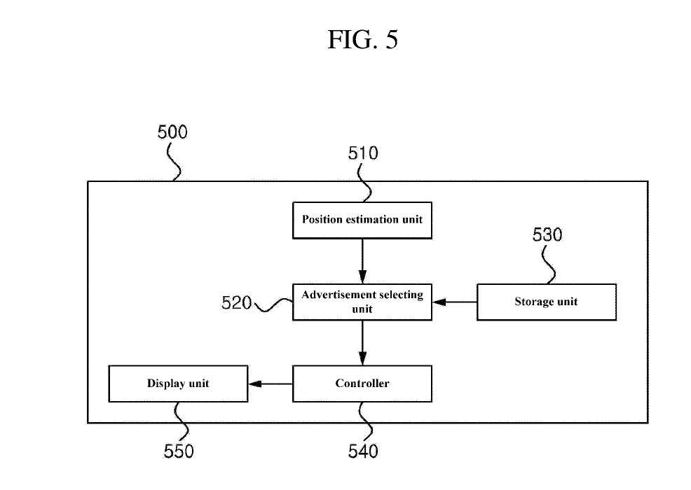

FIG. 5 is a block diagram illustrating a structure of an advertising device which selects and displays an advertisement depending on a position of a bus.

An advertising device 500 according to an exemplary embodiment may include a position estimation unit 510, an advertisement selecting unit 520, a storage unit 530, a controller 540, and a display unit 550.

The position estimation unit 510 may estimate a current position of a bus equipped with the advertising device 500. According to an aspect, the position estimation unit 510 may estimate the current position of the bus using a GPS or the like.

The storage unit 530 may store broadcast information, an advertisement, traffic information, or the like in the form of a video, an image, or the like. According to an aspect, a specific geographical position may be set for each of the stored video or image.

The advertisement selecting unit 520 may compare a position set for each video or image with an estimated current position of the bus to select an optimal video or image among the stored videos or images.

According to an aspect, when a position set for a video or image is included within a predetermined distance from an estimated position of the bus, the advertisement selecting unit 520 may select the video or image as an optimal video or image.

According to another aspect, when the position estimation unit 510 estimates a first position on a route as a current position of the bus, the advertisement selecting unit 520 may select a video or image, a set position of which is included within a predetermined distance from a second position on the route, as an optimal video or image.

The controller 540 may control the display unit 550 to display the select video or image on the outside of the bus.

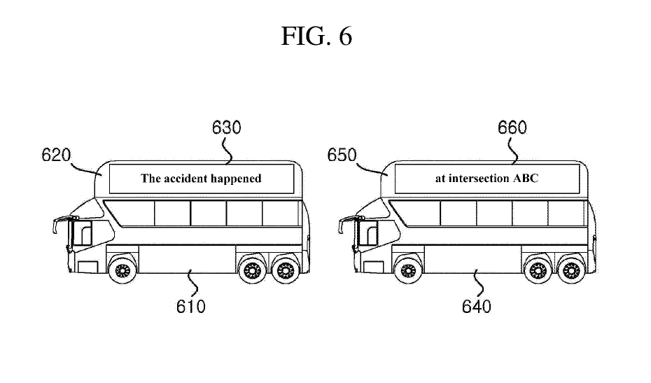

FIG. 6 is a drawing illustrating the concept of an advertising device which interacts with an advertising device installed on another bus and displays an advertisement.

Several buses may stop close to each other around a bus stop, an intersection, or a crosswalk. In this case, when advertising devices respectively installed on buses interact and operate with each other, broadcast information, an advertisement, traffic information, or the like may be more efficiently transmitted.

In FIG. 6, an advertising device 620 may be installed on a first bus 610. Further, an advertising device 650 may be installed on a second bus 640. The first bus 610 and the second bus 640 may stop close to each other around a bus stop, an intersection, or a crosswalk. In this case, display units 630 and 650 of the advertising devices 620 and 650 respectively installed on the first and second buses 610 and 640 may be located close to each other.

According to an aspect, the advertising devices 620 and 650 respectively installed on the first and second buses 610 and 640 may interact and operate with each other. In this case, the advertising devices 620 and 650 may display only a portion of one common message on the displays 630 and 660, respectively. In other words, a selected video or image displayed on each of the advertising devices 620 and 650 may be a portion of the entire video or image, and the other of the entire video or image may be displayed on a display device installed on another bus. A pedestrian may simultaneously recognize an advertisement, information, or the like displayed on the two display units 630 and 660 and may determine the entire message.

Referring to FIG. 6, the display unit 630 of the advertising device 620 installed on the first bus 610 may display only the phrase “The accident happened”. Further, the display unit 660 of the advertising device 650 installed on the second bus 640 may display only the phrase “at intersection ABC”. When a pedestrian is unable to determine accurate information using only each information, but recognizes the information displayed on the display units 630 and 660 of the two advertising device 620 and 650 together, he or she may determine accurate information.

In FIG. 6, an embodiment is exemplified as only the two advertising devices 620 and 650 interact with each other. However, embodiments are not limited thereto. According to various embodiments, three or more advertising devices may interact with one another. When a plurality of advertising devices interact with one another, since more messages are able to be transmitted using a wider space, an advertising effect may be optimized.

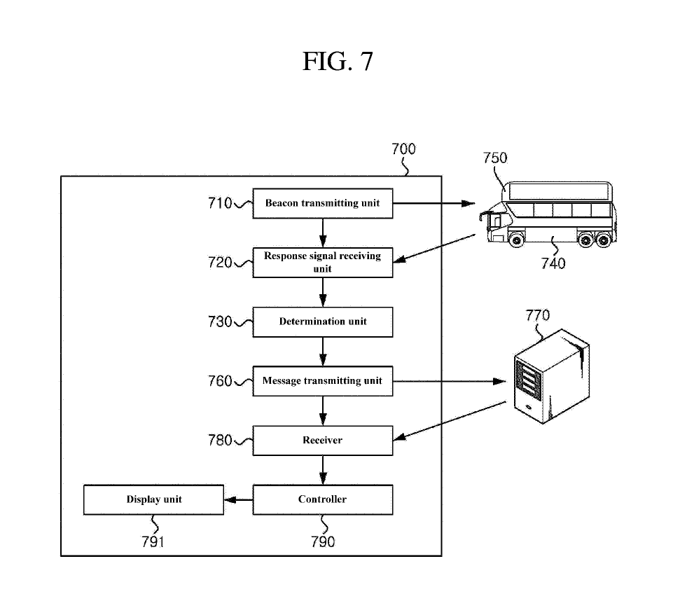

FIG. 7 is a block diagram illustrating a structure of an advertising device which interacts with an advertising device installed on another bus.

An advertising device 700 according to an exemplary embodiment may include a beacon transmitting unit 710, a response signal receiving unit 720, a determination unit 730, a message transmitting unit 760, a receiver 780, a controller 790, and a display unit 791.

According to an aspect, when a bus equipped with the advertising device 700 stops adjacent to another bus 740, the advertising device 700 may interact and operate with an advertisement device 750 installed on the other bus 740. According to an aspect, when a position of the bus equipped with the advertising device 700 is included in a predetermined range from a position of the other bus 740, the advertising device 700 may determine that the bus equipped with the advertising device 700 is adjacent to the other bus 740. Further, when a speed of the bus equipped with the advertising device 700 is less than or equal to a predetermined threshold or when the bus equipped with the advertising device 700 maintains the predetermined threshold or less over a predetermined time, the advertising device 700 may determine that the bus equipped with the advertising device 700 stops.

The beacon transmitting unit 710 may transmit a beacon signal. Herein, a power of the beacon signal transmitted by the beacon transmitting unit 710 may have a very low value, and the beacon signal may be transmitted within only dozens of meters or hundreds of meters. According to an aspect, the beacon signal may include an identifier of the bus equipped with the advertising device 700 or an identifier of the advertising device 700.

When the advertising device 750 installed on the other bus 740 receives the beacon signal, it may be seen that the advertising device 700 and the advertising device 750 are close enough to interact and operate with each other. Receiving the beacon signal, the advertising device 750 may transmit a response signal, including an identifier of the other bus 740 or an identifier of the advertising device 750, in response to the beacon signal.

The response signal receiving unit 720 may receive the response signal from the advertising device 750.

When receiving the response signal, the determination unit 730 may determine that the bus equipped with the advertising device 700 and the other bus 740 are close to each other and that the advertising device 700 and the advertising device 750 are close to each other.

The message transmitting unit 760 may transmit a connection advertisement request message including an identifier of the bus, an identifier of the advertising device 700, an identifier of the other bus 740, or an identifier of the advertising device 750 to a server 770.

The server 770 may receive the connection advertisement request message and may determine that that the bus and the other bus 740 are located close to each other or the advertising devices 700 and 750 are located close to each other. In this case, the server 770 may select a video or image the two advertising devices 700 and 750 may display by interacting with each other and may transmit the selected video or image.

The receiver 780 may receive the selected video or image from the server 770. Herein, the selected video or image may be a portion of the entire video or image, and the other of the entire video or image may be transmitted to the advertising device 750.

The controller 790 may control the display unit 791 to display the received video or image.

The other of the entire video or image, transmitted to the advertising device 750, may be displayed on the advertising device 750.

As such, an embodiment is exemplified as the advertising device 700 determines that the advertising device 750 is close to the advertising device 700 using the beacon signal. However, embodiments are not limited thereto. According to another embodiment, a server may determine whether the advertising device 700 and the advertising device 750 are close to each other. For example, in FIG. 4, a transmitter 420 may transmit an estimated current position of the bus to a server 460. The server 460 may receive an estimated current position of another bus from another advertising device installed on another bus and may compare the estimated position of the bus with the estimated position of the other bus. When a difference between the positions is within a predetermined range, the server 460 may determine that the two buses are close to each other or may determine that advertising devices respectively installed on the two buses are close to each other. In this case, the server 460 may select a video or image the two advertising devices may display by interacting with each other and may transmit the selected video or image. A receiver 430 may receive the selected video or image. A controller 440 may control the display unit 450 to display the received video or image.

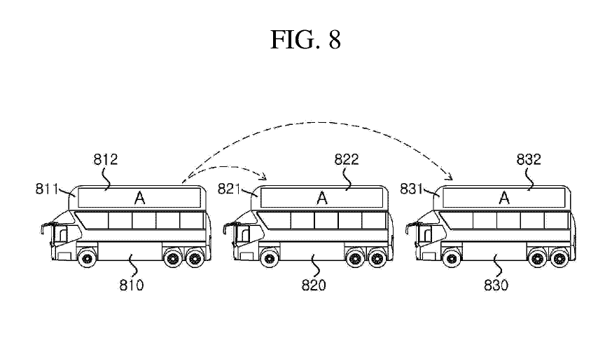

FIG. 8 is a drawing illustrating the concept of controlling another advertising device installed on another bus.

Buses may stop close to each other around a bus stop, an intersection, or a crosswalk. In this case, when advertising devices respectively installed on the buses which are close to each other interact and operate with each other, for example, when the advertising devices sequentially turn on/off their display units, an advertising effect may be optimized.

Referring to FIG. 8, a first advertising device 811 installed on a first bus 810 may display the video or image “A” on a display unit 812. A second advertising device 821 installed on a second bus 820 and a third advertising device 831 installed on a third bus 830 may display the same video or image “A” on display units 822 and 832, respectively.

The master advertising device 811 selected among the plurality of advertising devices 811, 821, and 831 may transmit a control signal to the other advertising devices 821 and 831. The other advertising devices 821 and 831 may perform an operation of turning on/off the display units 822 and 832 depending on the control signal.

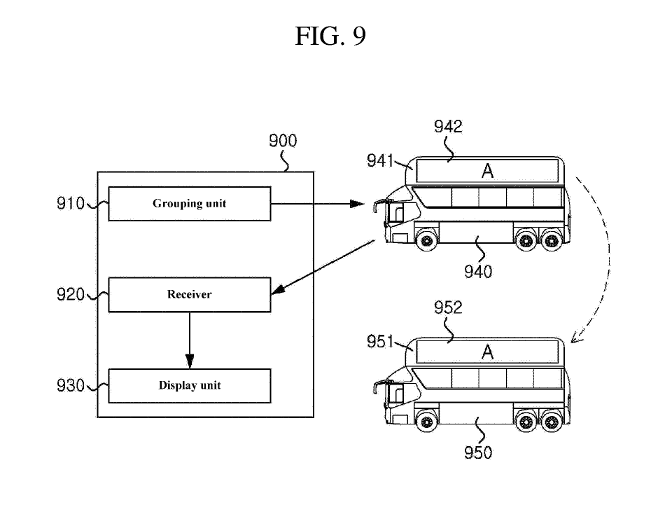

FIG. 9 is a block diagram illustrating a structure of an advertising device which controls another advertising device installed on another bus.

An advertising device 900 according to an exemplary embodiment may include a grouping unit 910, a receiver 920, and a display unit 930.

The grouping unit 910 may recognize other buses 940 and 950 adjacent to a bus equipped with the advertising device 900 or advertising devices 941 and 951 respectively installed on the other buses 940 and 950 and may form a group with the advertising devices 941 and 951 respectively installed on the other buses 940 and 950. According to an aspect, the grouping unit 910 may form a group in consideration of at least one of a traveling direction of each of the bus equipped with the advertising device 900 and the other buses 940 and 950, a speed of each of the bus and the other buses 940 and 950, whether each of the bus and the other buses 940 and 950 stops, or a time when each of the bus and the other buses 940 and 950 stops. According to an aspect, the two or more advertising devices 900, 941, and 951 may be included in the formed group.

When the plurality of advertising devices 900, 941, and 951 are included in the group, any one of the advertising devices 900, 941, and 951 may be selected as a master advertising device. In this case, an advertising device in which the longest time elapses after being included in the group may be selected as a master advertising device. In this case, an advertising device installed on a bus which first stops or a bus which last stops may be selected as a master advertising device. In FIG. 9, it may be assumed that the advertising device 941 is selected as a master advertising device.

The receiver 920 may receive a control signal from the master advertising device 941.

The display unit 930 may display a video or image depending on the control signal. For example, the control signal may include an instruction for an ON/OFF state of the display unit 930 at a specific time. The advertising device 900 may control or turn on/off the display unit 930 depending on the control signal to interact with the other advertising devices 941 and 951.

According to another aspect, a server may select a master advertising device between the advertising devices 941 and 951 included in the group. For example, a transmitter (not shown) may transmit a list of the advertising device 900 and the other advertising devices 941 and 951 included in the group to the server. In this case, the server may select any one of the advertising devices 900, 941, and 951 included in the list as a master advertising device. The receiver 920 may receive information about the master advertising device and may interact with the other advertising devices 941 and 951 under control of the master advertising device.

According to an aspect, the receiver 920 may receive a video or image as well as a control signal from the master advertising device 941. In this case, the display unit 930 may display the received video or image.

According to another aspect, the receiver 920 may receive a video or image from the server with reference to the control signal. In this case, the display unit 930 may display the received video or image.

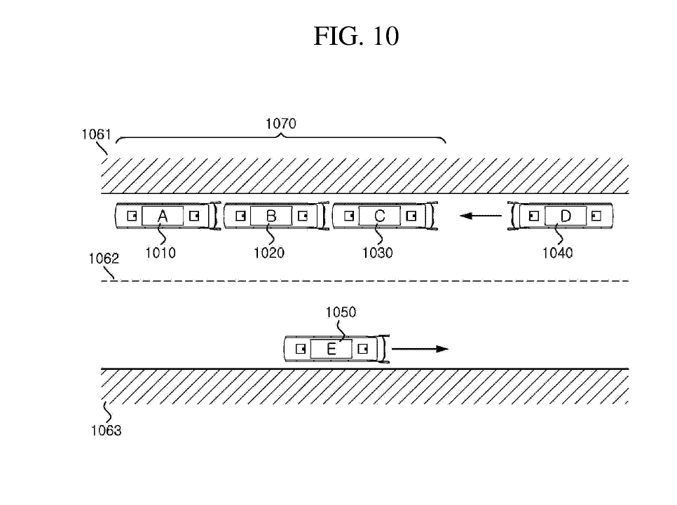

FIG. 10 is a drawing illustrating the concept of grouping advertising devices respectively installed on buses which stop at a bus stop and displaying an advertisement.

Each of regions 1061 and 1063 may indicate a sidewalk, and a region 1062 may indicate a roadway. Each of a first bus 1010, a second bus 1020, and a third bus 1030 may be in a state where they stop at a bus stop 1070. A fourth bus 104 may be in a state where it enters the bus stop 1070. A fifth bus 1050 may be in a state where it travels in a direction opposite to the first to fourth buses 1010, 1020, 1030, and 1040.

In FIG. 10, advertising devices respectively installed on the first bus 1010, the second bus 1020, and the third bus 1030 which stop at the bus stop 1070 may form a group. The advertising devices may form the group in consideration of at least one of a traveling direction of each of the first to third buses 1010, 1020, and 1030, a speed of each of the first to third buses 1010, 1020, and 1030, whether each of the first to third buses 1010, 1020, and 1030 stops, or a time when each of the first to third buses 1010, 1020, and 1030 stops. Thus, an advertising device installed on the fifth bus 1050 which travels in the opposite direction or an advertising device installed on the fourth bus 1040 which currently enters the bus stop 1070 may be excluded from the group. According to an aspect, when the fourth bus 1040 enters the bus stop 1070 to stop at the bus stop 1070, the advertising device installed on the fourth bus 1040 may be included in the group.

Any one of the advertising devices included in the group may be selected as a master advertising device. The master advertising device may be randomly selected, or the oldest advertising device after being included in the group among the advertising devices included in the group may be selected as the master advertising device.

The advertising devices included in the group may interact and operate with each other to optimize an advertising effect under control of the master advertising device.

For example, after a video or image is displayed on only a first advertising device installed on the first bus 1010, a display unit of the first advertising device may stop displaying the video or image and the video or image may be displayed on only a second advertising device installed on the second bus 1020. Thereafter, a display unit of the second advertising device may stop displaying the video or image, and the video or image may be displayed on only a third advertising device installed on the third bus 1030.

Likewise, the advertising devices included in the group may increase an advertising effect in a manner to sequentially turn on/off their display units.

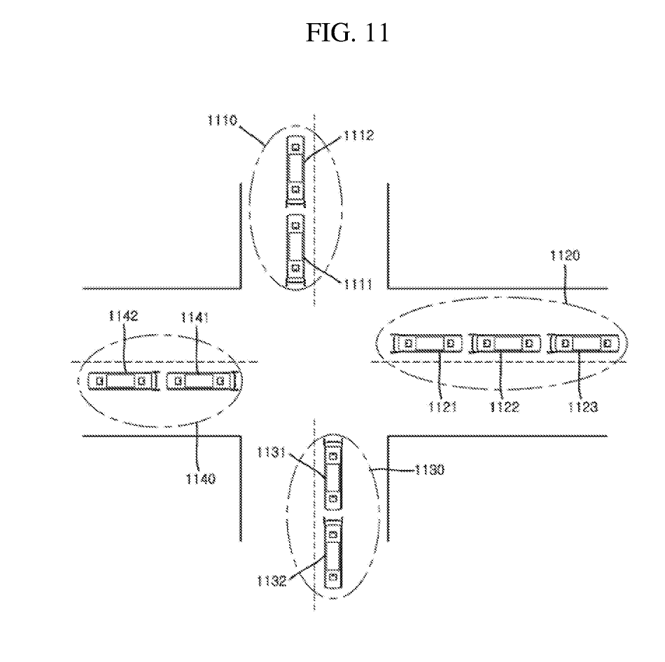

FIG. 11 is a drawing illustrating the concept of grouping advertising devices respectively installed on buses which stop at an intersection and displaying an advertisement.

Buses 1111, 1112, 1121, 1122, 1123, 1131, 1132, 1141, and 1142 to travel in each direction depending on a traffic signal may stop at an intersection. In this case, advertising devices respectively installed on the buses 1111, 1112, 1121, 1122, 1123, 1131, 1132, 1141, and 1142 may form a group in consideration of a traveling direction of each of the buses 1111, 1112, 1121, 1122, 1123, 1131, 1132, 1141, and 1142 respectively equipped with the advertising devices, a speed of each of the buses 1111, 1112, 1121, 1122, 1123, 1131, 1132, 1141, and 1142, whether each of the buses 1111, 1112, 1121, 1122, 1123, 1131, 1132, 1141, and 1142 stops, a time when each of the buses 1111, 1112, 1121, 1122, 1123, 1131, 1132, 1141, and 1142 stops, or the like. Considering the traveling direction of each of the buses 1111, 1112, 1121, 1122, 1123, 1131, 1132, 1141, and 1142, the speed of each of the buses 1111, 1112, 1121, 1122, 1123, 1131, 1132, 1141, and 1142, whether each of the buses 1111, 1112, 1121, 1122, 1123, 1131, 1132, 1141, and 1142 stops, the time when each of the buses 1111, 1112, 1121, 1122, 1123, 1131, 1132, 1141, and 1142 stops, or the like, advertising devices respectively installed on buses located on the same lane may form groups 1110, 1120, 1130, and 1140.

Advertising devices included in each of the groups 1110, 1120, 1130, and 1140 may interact and operate with each other, for example, may sequentially turn on/off display units in a similar manner to an embodiment in which buses stop at a bus stop of FIG. 10.

When some of buses move since a traffic signal is changed, advertising devices respectively installed on the buses may be excluded from the group in consideration of a speed of each of the buses or the like. Further, an advertising device installed on a bus which newly stops may be included in the group.

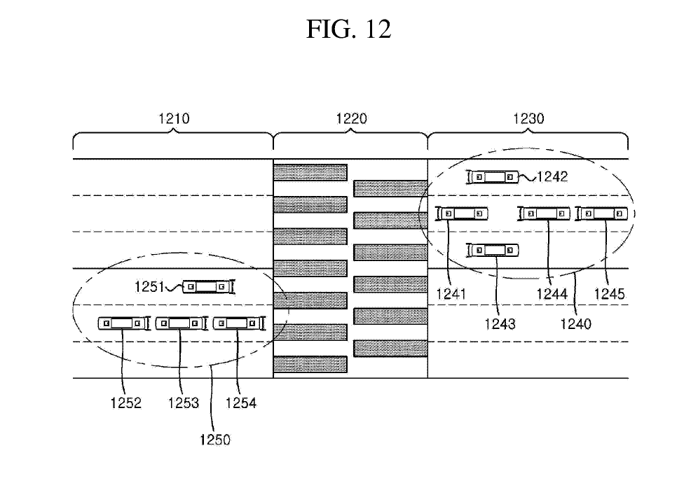

FIG. 12 is a drawing illustrating the concept of grouping advertising devices respectively installed on buses which stop around a crosswalk and displaying an advertisement.

In FIG. 12, buses 1241 to 1245 and 1251 to 1254 may be in a state where they stop on both lanes 1210 and 1230 about a crosswalk 1220. Advertising devices respectively loaded onto the buses 1241 to 1245 and 1251 to 1254 may form a group in consideration of a traveling direction of each of the buses 1241 to 1245 and 1251 to 1254, a speed of each of the buses 1241 to 1245 and 1251 to 1254, whether each of the buses 1241 to 1245 and 1251 to 1254 stops, a time when each of the buses 1241 to 1245 and 1251 to 1254 stops, or the like. Advertising devices included in each of groups 1240 and 1250 may optimize an advertising effect by sequentially turning on/off display units in a similar manner to that in FIG. 10.

According to an aspect, advertising devices may operate in an order of a time when each of the buses 1241 to 1245 and 1251 to 1254 arrives at the crosswalk 1220, a distance from the crosswalk 1220, or the like.

The methods according to the above-described exemplary embodiments of the inventive concept may be recorded in computer-readable media including program instructions to implement various operations embodied by a computer. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Program instructions include both machine code, such as produced by a compiler, and files containing higher level code that may be executed by the computer using an interpreter. The described hardware devices may be configured to act as one or more software modules to perform the operations of the above-described exemplary embodiments of the inventive concept, or vice versa.

According to embodiments, the advertising device may display an optimized advertisement video or an optimized advertisement image depending on a position of a bus.

According to embodiments, the advertising device may optimize an advertising effect by grouping advertising devices respectively installed on buses.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

What is claimed is:

1. An advertising device installed on a bus which travels along a route, the advertising device comprising:
a storage unit configured to store a video or image;
a display unit; and
a playback unit configured to load the video or image to display the video or image on the display unit.

2. The advertising device of claim 1, further comprising:
a power supply unit configured to receive power from a battery of the bus and supply the received power to the display unit.

3. The advertising device of claim 1, further comprising:
a fixing unit configured to fix the advertising device to an upper end of the bus using a screw, a rivet, a frame, or adhesive.

4. The advertising device of claim 1, wherein the playback unit is configured to:
when a position set for the video or image is located within a predetermined distance from a position of the bus, display the video or image on the display unit.

5. The advertising device of claim 1, wherein the playback unit is configured to:
when the bus is in a first position on the route, load and display a video or image corresponding to a second position on the route in the video or image.

6. The advertising device of claim 1, wherein the video or image comprises at least one of broadcast information, an advertisement, and traffic information associated with the route.

7. An advertising device installed on an upper end of a bus which travels along a route, the advertising device comprising:
a position estimation unit configured to estimate a current position of the bus;
a display unit; and
a controller configured to control the display unit to display a video or image selected based on the estimated position.

8. The advertising device of claim 7, further comprising:
a transmitter configured to transmit information about the estimated position to a server; and
a receiver configured to receive a video or image selected according to the estimated position from the server,
wherein the controller is configured to:
control the display unit to display the received video or image on the outside of the bus.

9. The advertising device of claim 7, further comprising:
a storage unit configured to store a plurality of videos or images; and
an advertisement selecting unit configured to compare a position set for each of the plurality of stored videos or images with the estimated position and select a video or image to be displayed among the plurality of stored videos or images,
wherein the controller is configured to:
control the display unit to display the selected video or image on the outside of the bus.

10. The advertising device of claim 7, wherein the video or image is selected when a position set for the video or image is located within a predetermined distance from the estimated position.

11. The advertising device of claim 7, wherein the position estimation unit is configured to:
estimate a first position on the route as a current position of the bus, and
wherein the video or image is selected when a position set for the video or image is located within a predetermined distance from a second position on the route.

12. The advertising device of claim 7, further comprising:
a transmitter configured to transmit information about the estimated position to a server; and
a receiver,
wherein the estimated position is used to determine, by the server, an administrative district where the bus is located, and
wherein the receiver is configured to:
receive a video or image, a set position of which corresponds to the administrative district.

13. The advertising device of claim 7, wherein the selected video or image is a portion of the entire video or image, and
wherein the other of the entire video or image is displayed on a display device installed on another bus.

14. The advertising device of claim 13, wherein the controller is configured to:
when a position of the bus is located within a predetermined range from a position of the other bus, the controller is configured to control the display unit to display the selected video or image.

15. The advertising device of claim 13, further comprising:
a transmitter configured to transmit information about the estimated current position of the bus to a server; and
a receiver,
wherein the current position of the bus is compared with a position of the other bus,
wherein the receiver is configured to receive the selected video or image as a result of the comparison, and
wherein the controller is configured to control the display unit to display the received video or image.

16. The advertising device of claim 13, further comprising:
a beacon transmitting unit configured to transmit a beacon signal;
a response signal receiving unit configured to, when the other bus receives the beacon signal, receive a response signal including an identifier of the other bus from the other bus; and
a determination unit configured to, when the response signal is received, determine that the bus is close to the other bus.

17. The advertising device of claim 16, further comprising:
a message transmitting unit configured to transmit a connection advertisement request message including an identifier of the bus and an identifier of the other bus to a server; and
a receiver configured to receive the selected video or image from the server,
wherein the controller is configured to control the display unit to display the received video or image, and
wherein the other of the entire video or image is transmitted to the other bus with reference to the identifier of the other bus, the identifier being included in the connection advertisement request message.

18. An advertising device installed on an upper end of a bus which travels along a route, the advertising device comprising:
a grouping unit configured to recognize another bus adjacent to the bus or another advertising device installed on the other bus and form a group with the other advertising device;
a receiver configured to receive a control signal from a master advertising device selected between the advertising device and the other advertising device; and
a display unit configured to display a video or image based on the control signal.

19. The advertising device of claim 18, wherein the advertising device installed on a bus which first stops between the bus and the other bus is selected as the master advertising device.

20. The advertising device of claim 18, further comprising:
a transmitter configured to transmit a list of the advertising device and the other advertising device to a server,
wherein the receiver is configured to receive information about a master advertising device selected by the server among the advertising devices included in the list.

21. The advertising device of claim 18, wherein the receiver is configured to receive the video or image from the master advertising device, and
wherein the display unit is configured to display the received video or image.

22. The advertising device of claim 18, wherein the receiver is configured to receive the video or image from a server with reference to the control signal, and
wherein the display unit is configured to display the received video or image.

23. The advertising device of claim 18, wherein the grouping unit is configured to form the group in consideration of at least one of a traveling direction of each of the bus and the other bus, a speed of each of the bus and the other bus, whether each of the bus and the other bus stops, or a time when each of the bus and the other bus stops.
